(19) United States
(12) Patent Application Publication
(10) Pub. No.: US 2014/0004352 A1
(43) Pub. Date: Jan. 2, 2014

(54) METAL-CLAD HYBRID ARTICLE HAVING SYNERGISTIC MECHANICAL PROPERTIES

(71) Applicants: Jonathan McCrea, Toronto (CA); Herath Katugaha, Toronto (CA); Gino Palumbo, Toronto (CA); Konstantinos Panagiotopoulos, Etobicoke (CA); Iain Brooks, Toronto (CA); Nandakumar Nagarajan, Burlington (CA); Gerhard Hirmer, Aurora (CA)

(72) Inventors: Jonathan McCrea, Toronto (CA); Herath Katugaha, Toronto (CA); Gino Palumbo, Toronto (CA); Konstantinos Panagiotopoulos, Etobicoke (CA); Iain Brooks, Toronto (CA); Nandakumar Nagarajan, Burlington (CA); Gerhard Hirmer, Aurora (CA)

(73) Assignee: Integran Technologies Inc., Mississauga (CA)

(21) Appl. No.: 13/538,193

(22) Filed: Jun. 29, 2012

(51) Int. Cl. B32B 15/092; B32B 37/12; B32B 15/08

(52) U.S. Cl. 428/416; 428/457; 156/154; 216/37

(57) ABSTRACT

An article of manufacture includes a substrate having an outer surface clad with a metal construct including one or more continuous metal layers, at least one of which is an amorphous layer or a microcrystalline layer having a grain size below 5000 nm. A bonding layer is provided between the substrate and the layered metallic construct so that the bonding layer is in direct contact with the substrate and with the layered metallic construct. The bonding layer is made of a substantially fully cured resin including at least 10% of a rubber. The layered metallic construct has peel strength greater than 10N/cm. Also provided is a process for making the article including coating an article outer surface with a bonding layer and a layered metallic construct. The bonding layer is substantially fully cured before the layered metal construct is bonded to the article. The coated article is annealed.

### BACKGROUND OF THE INVENTION

1. Field of the Invention

The invention relates generally to an article of manufacture comprising a substrate, a layered metal construct coating all or part of the outer surface of the substrate, and a bonding layer disposed between the substrate and the layered metal construct. The invention further relates to a process for making the article of manufacture.

2. Description of the Related Art

It is known to provide a substrate with a thin metal coating. In particular substrates made of metallic and polymeric materials benefit from having a metal coating in terms of attractiveness of appearance, electrical conductivity and hardness of the surface. These are superficial benefits as thin metal coatings typically do not appreciably contribute to the strength and toughness of the substrate.

U.S. Pat. No. 4,389,268 to Oshima et al. discloses a method of producing a laminate for receiving a chemical plating. The method comprises the step of forming a thermosetting adhesive layer on at least one surface of a peel-resistant insulating sheet. After the adhesive layer has been cured substantially completely, the adhesive-bearing sheet is bonded to a base material so as to obtain an integral laminate. The outermost surface of the laminate is coarsened on the side of the insulating sheet, and a chemical plating is applied to the coarsened surface of the laminate. The method is disclosed to be suitable for producing printed circuit boards wherein the metal coating imparts electrical conductivity to the laminate.

U.S. Pat. No. 4,707,394 to Chant discloses a process for producing circuit boards. The process comprises the coating of a resinous substrate with a fluid mixture of an epoxy polymer component and a rubber polymer which is interactive therewith. The coating is partially cured. The exposed surface of this coating is then etched, and metal is deposited on the surface to form a conductive layer. A conductive pattern is formed in the conductive layer. Heat and pressure are applied to the conductive pattern and the coating to fully cure the coating thereby bonding the coating to the metal layer and the conductive pattern to the resinous substrate. The method is disclosed to be suitable for producing printed circuit boards wherein the metal coating provides an electrical conductivity contribution to the laminate.

U.S. Pat. No. 5,882,954 to Raghava et al. discloses a method for adhering metallizations to a substrate. The method comprises the steps of (1) providing a substrate having a first surface; (2) applying a coating atop the first surface, such that the coating has a second surface bonded to the first surface, and a third surface generally conforming with the second surface; (3) etching away material from the third surface, so as to roughen and form pits in the third surface; and (4) attaching a metallization to the pits in the third surface by plating, sputtering, or similar means. The substrate can be a thermoplastic material, or a thermoset material, or a combination. The method is suitable for the manufacture of circuit boards wherein the metal coating provides an electrical conductivity contribution to the laminate.

U.S. Pat. No. 6,355,304 to Braun discloses a method for applying a metal or metallic plating. The method comprises the steps of providing a substrate, including polymeric and elastomeric substrates; coating the substrate with a relatively thin layer of epoxy-solvent combination; metal plating the coated substrate; and fully curing the epoxy. The method is suitable for the manufacture of metal coatings that contribute superficial properties such as attractiveness of appearance, electrical conductivity and hardness of the surface.

U.S. Pat. No. 7,384,532 to Parsons, II et al. discloses a process for electroplating a wide variety of non-conductive substrates. The process involves application of a platable coating composition to the substrate prior to plating. The coating is cured to render the substrate more receptive to conventional plating techniques. The process utilizes an epoxy resin system that upon being cured is receptive to electroless plating and electrolytic plating techniques. The method is suitable for the manufacture of metal coatings that contribute superficial properties such as attractiveness of appearance, electrical conductivity and hardness of the surface.

US Patent Application Publication 2004/0038068 discloses a decorative and/or protective coating on an article. The coating comprises a polymeric basecoat, which is cured at sub-atmospheric pressures. One or more vapor-deposited layers are deposited onto the cured polymeric basecoat.

Various patents address the fabrication of articles containing fine-grained metals, alloys and metal matrix composites (MMCs) for a variety of applications:

Erb in U.S. Pat. No. 5,352,266 (1994), and U.S. Pat. No. 5,433,797 (1995), both assigned to the same assignee as the present application, describe a process for producing nanocrystalline materials, particularly nanocrystalline nickel. The nanocrystalline material is electrodeposited onto the cathode in an aqueous acidic electrolytic cell by application of a pulsed current.

Palumbo in US 2005/0205425 A1 and DE 10228,323 A1 (2004), both assigned to the same assignee as the present application, disclose a process for forming coatings or freestanding deposits of nanocrystalline metals, metal alloys or metal matrix composites. The process employs tank, drum plating or selective plating processes using aqueous electrolytes and optionally a non-stationary anode or cathode. Nanocrystalline metal matrix composites are disclosed as well.

Palumbo in U.S. Pat. No. 7,320,832 (2008), U.S. Pat. No. 7,824,774 (2010) and U.S. Pat. No. 7,910,224 (2011), all assigned to the same assignee as the present application, disclose means for matching the coefficient of thermal expansion (CTE) of fine-grained metallic coating to the substrate by adjusting the composition of the alloy and/or by varying the chemistry and volume fraction of particulates embedded in the coating. The fine-grained metallic coatings are particularly suited for strong and lightweight articles, precision molds, sporting goods, automotive parts and components exposed to thermal cycling and include polymeric substrates. Maintaining low CTEs (<25×10⁻⁶ K⁻¹) and matching the CTEs of the fine-grained metallic coating with the CTEs of the substrate minimizes dimensional changes during thermal cycling and preventing delamination. Palumbo provides no information on the adhesion strength.

Palumbo in U.S. Pat. No. 7,354,354 (2008) and U.S. Pat. No. 7,553,553 (2010), both assigned to the same assignee as the present application, disclose lightweight articles comprising a polymeric material at least partially coated with a fine-grained metallic material. The fine-grained metallic material has an average grain size of 2 nm to 5,000 nm, a thickness between 25 micron and 5 cm, and a hardness between 200 VHN and 3,000 VHN. The lightweight articles are strong and exhibit high coefficients of resilience and a high stiffness and are particularly suitable for a variety of applications including aerospace and automotive parts, sporting goods, and the like. To enhance the adhesion of the metallic coating the surface to be coated is roughened by any number of suitable means including, e.g., mechanical abrasion, plasma and chemical etching. Palumbo provides no information on thermal cycling performance or adhesion strength.

Tomantschger in US 2009/0159451 (2009), assigned to the same assignee as the present application, discloses variable property deposits (graded and/or layered) of fine-grained and amorphous metallic materials, optionally containing solid particulates, on a variety of substrates, including polymeric, for sporting goods, cell phones, automotive components, gun barrels and orthopedic applications.

Tomantschger in US 2010/0304065 and US 2010/0304171, both assigned to the same assignee as the present application, describes metal-clad polymer articles containing structural fine-grained and/or amorphous metallic coatings/layers optionally containing solid particulates dispersed therein. The metallic coatings are particularly suited for strong and lightweight articles, precision molds, sporting goods, automotive parts and components exposed to thermal cycling although the coefficient of linear thermal expansion (CLTE) of the metallic layer and the substrate are mismatched. The interface between the metallic layer and the polymer is suitably pretreated to withstand thermal cycling without failure. Intermediate layers between the coating and substrate are disclosed, including compositions selected from a polymeric materials list including partly cured layers prior to coating and finishing heat treatment, also cured polymeric paint (carbon, graphite, Cu, Ag filled curable polymers, adhesive layer).

McCrea in US Patent Application Publication 2010/0304063, assigned to the same assignee as the present application, describes metal-coated polymer articles containing structural substantially porosity-free, fine-grained and/or amorphous metallic coatings/layers optionally containing solid particulates dispersed therein on polymer substrates. The substantially porosity-free metallic coatings/layers/patches are applied to polymer or polymer composite substrates to provide, enhance or restore vacuum/pressure integrity and fluid sealing functions. Polymer intermediate layers are disclosed, including partly cured layers prior to coating and using a post-finish heat-treatment, also curable polymeric conductive paints (carbon, graphite, Cu, Ag filled curable polymers, adhesive layer).

Wang in US unpublished Patent Application Publication Ser. No. 13/279,731, assigned to the same assignee as the present application, describes a metal-clad polymer article that includes a polymeric material with or without particulate addition. The polymeric material defines a permanent substrate. A metallic material covers at least part of a surface of the polymeric material. The metallic material has a microstructure which, at least in part, is at least one of fine-grained with an average grain size between 2 and 5,000 nm and amorphous. The metallic material has an elastic limit between 0.2% and 15%. At least one intermediate layer can be provided between the polymeric material and the metallic material. A stress on the polymeric material, at a selected operating temperature, reaches at least 60% of its ultimate tensile strength at a strain equivalent to the elastic limit of said metallic material.

Thus, there is a particular need for articles of manufacture comprising a substrate, a bonding layer, and a layered metallic construct comprising a microcrystalline and/or amorphous metal layer having a grain size of less than 5000 nm whose properties, for a given article weight and/or density, are uniquely achieved by the mechanically cooperative combination of the layered metallic construct, bonding layer, and the substrate, and not individually by any of the components.

### BRIEF SUMMARY OF THE INVENTION

The methods disclosed in the prior art are suitable for the manufacture of metal coatings that typically do not appreciably contribute to the strength and toughness of the substrate. The present invention addresses these problems by providing an article of manufacture comprising:

a substrate, in direct contact with

a bonding layer of a substantially fully cured resin comprising at least 10% of a rubber; said bonding layer being in direct contact with one surface of

a layered metallic construct comprising one or more continuous metal layers wherein at least one of the continuous metal layers is a microcrystalline and/or amorphous metal layer having a grain size below 5000 nm and wherein the layered metallic construct has a peel strength>10N/cm.

Another aspect of the invention comprises a process for providing an article of manufacture with a metal coating, said process comprising the steps of:

providing a substrate having an outer surface;

coating the outer surface of the substrate, or a predetermined portion thereof, with a composition comprising a curable resin;

substantially fully curing the curable resin to form a bonding layer;

coating the bonding layer with a layered metallic construct comprising one or more continuous metal layers wherein at least one of the continuous metal layers is a microcrystalline and/or amorphous metal layer having a grain size below 5000 nm;

annealing the coated article.

### BRIEF DESCRIPTION OF THE DRAWINGS

The features and advantages of the invention will be appreciated upon reference to the following drawings, in which:

FIG. 1 is a graph showing the peel strength of the layered metal construct of an embodiment of the invention as a function of the amount of bonding material.

FIG. 2 is a graph showing the peel strength of the layered metal construct of various embodiments of the invention, with the bonding layer applied in one step or in two steps, respectively.

FIG. 3 is a graph showing the peel strength of the layered metal construct of an embodiment of the invention as a function of the curing time prior to application of the layered metallic construct.

FIG. 4 is a graph showing the isothermal TGA and DTA curves at 143° C. of the curing step prior to application of the layered metallic construct in the process of the invention.

FIG. 5 is a graph showing the peel strength of the layered metal construct of an embodiment of the invention as a function of standing time at room temperature elapsed between the curing step and the layered metal construct application step.

FIG. 6 is a graph showing the effect on peel strength of atmospheric exposure of the bonding layer prior to application of the layered metallic construct.

FIG. 7 is a graph showing the flexural stress-strain behavior of an article of the invention alongside that of an otherwise identical uncoated substrate.

FIG. 8 is a graph showing the flexural load-displacement behavior of an article of the invention alongside that of an otherwise identical article made with no bonding layer and that of an otherwise identical article made with an epoxy bonding layer.

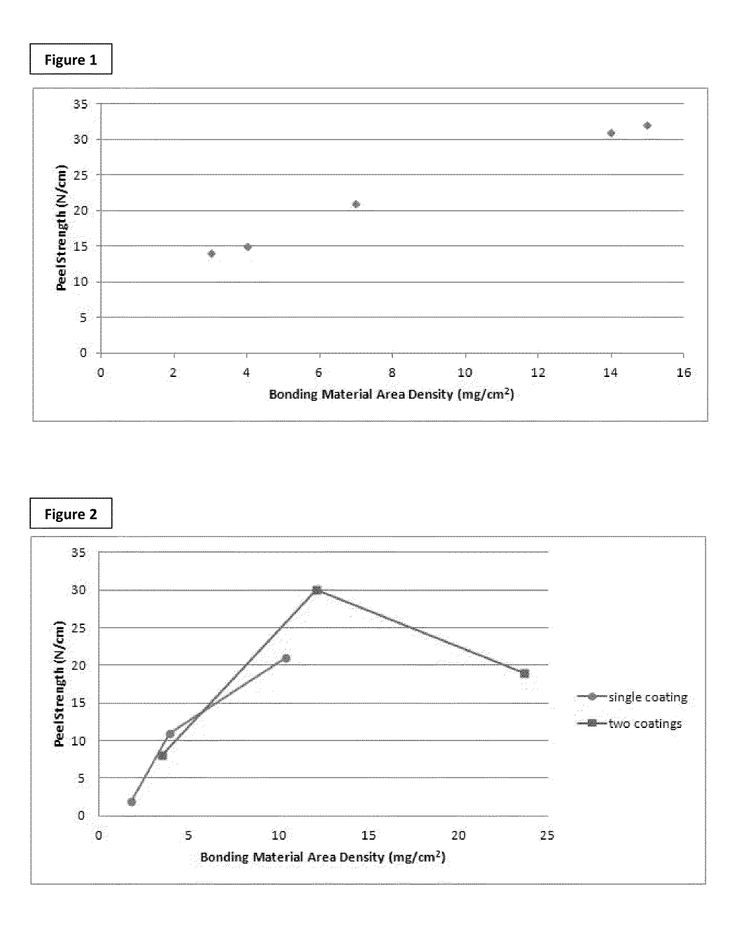

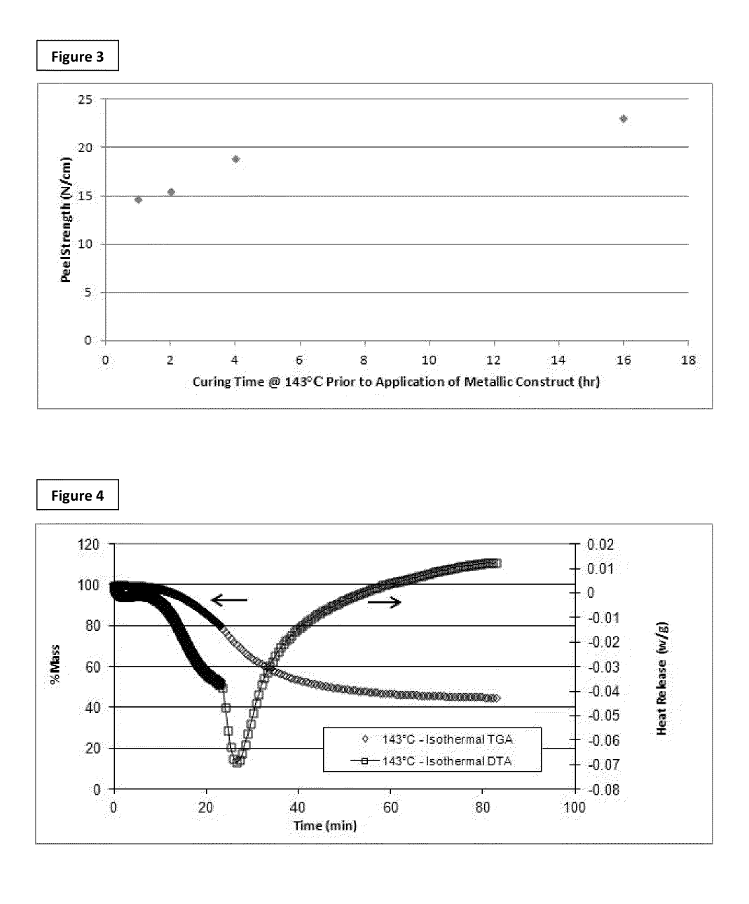

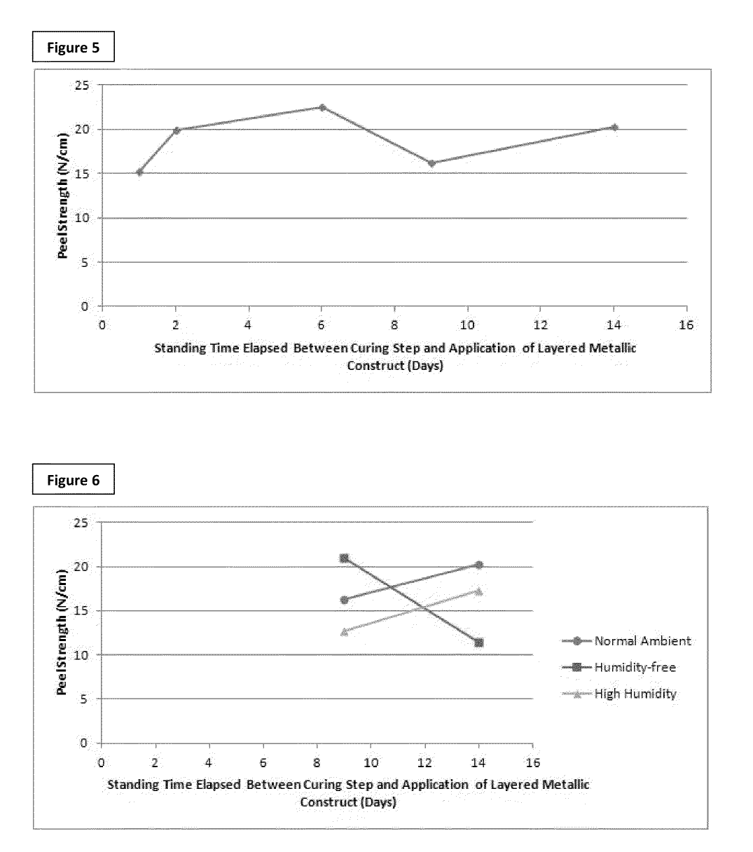

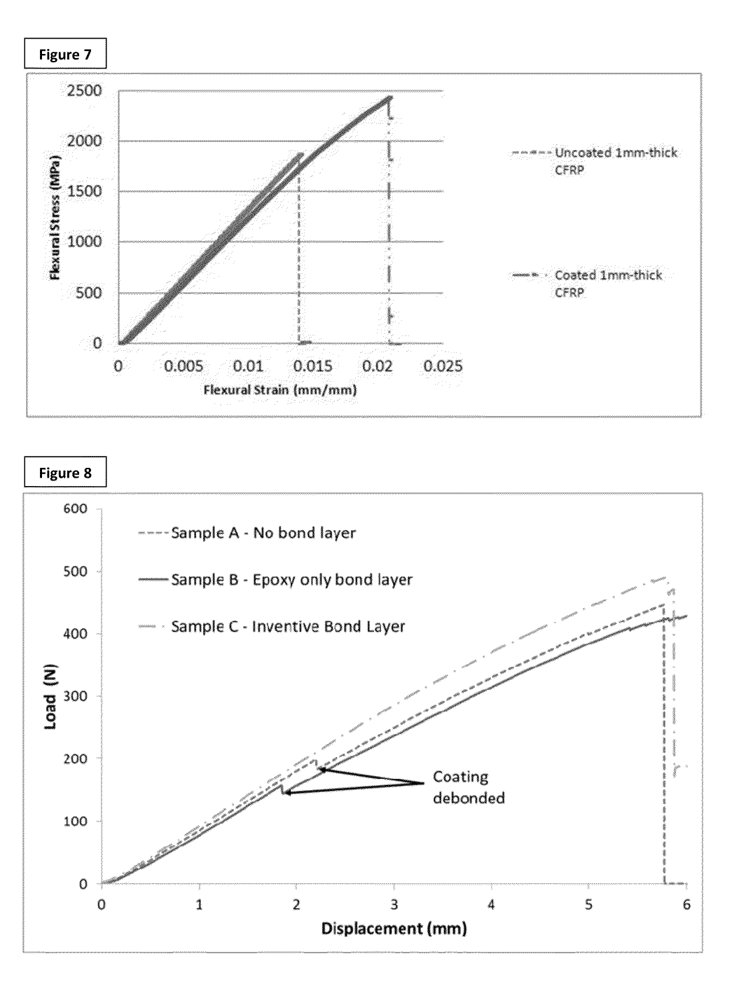

### DETAILED DESCRIPTION OF THE INVENTION

The following is a detailed description of the invention.

### DEFINITIONS

The term “article of manufacture” as used herein means a man-made tangible structural product. The article can have a use of its own, such as a tool or a sporting implement, or it can be used as a component of a larger structure. For example, the article can be a vehicle part, a tool part, a component for use in building construction, and the like. As used herein the term refers to a product of the process of the invention.

The term “substrate” as used herein means a man-made tangible structural product that can be used as a base for a metal-coated article of manufacture.

The term “bonding layer” as used herein refers to an intermediate layer between the substrate and the metal coating of the article of manufacture.

The term “curing” as used herein with reference to a resin means a cross-linking process that results in a three-dimensional molecular polymeric structure. The term “curable resin” refers to a resin composition that can be cured by crosslinking. The term “substantially fully cured” refers to a curable resin that has been subjected to a heat treatment at a temperature that is high enough, and during a time that is long enough, to result in substantial completion of the crosslinking process.

The term “rubber” as used herein refers to any polymer comprising an alkadiene as one of its monomers.

The term “metal layer construct” as used herein refers to a coating of one or more metal layers. The metal layer construct comprises at least one microcrystalline metal layer having a grain size below 5000 nm or at least one amorphous metal layer having a non-crystalline atomic structure. The process may require the bonding layer to be covered with a metallization layer so as to prepare it for application of the layered metallic construct of one or more microcrystalline and/or amorphous metal layers. In such case the metallization layer is considered part of the metal layer construct. In certain embodiments of the invention a plurality of two or more microcrystalline and/or amorphous metal layers are deposited. In such embodiments the metal layer construct consists of the plurality of microcrystalline and/or amorphous metal layers, together with a metallization layer, if present, and any other metal layers.

The term “microcrystalline” as used herein in reference to metal layers refers to metal layers having a grain size of 5000 nm or less. The term encompasses “nanocrystalline”, which is used herein for grain sizes less than 100 nm. The term “amorphous” as used herein in reference to metal layers refers to metal layers with a non-crystalline microstructure. The term encompasses solids with short-range atomic order.

The term “peel strength” as used herein refers to the force required to separate the metal layer construct from the bonding layer or the substrate, as measured according to standard ASTM B533-85. The dimension of peel strength is [force]/[length], and is usually expressed in N/cm.

The term “pull-off strength” as used herein refers to the strength of the adhesive bond between the layered metal construct and the bonding layer (or between the bonding layer and the substrate, whichever is lower). Pull-off strength is measured according to standard ASTM 4541D; its dimension is [force]/[length]. Test results are reported in psi units or, more properly, MPa (1 psi=0.0069 MPa).

In its broadest aspect the present invention relates to article of manufacture comprising:

a substrate, in direct contact with

a bonding layer of a substantially fully cured resin comprising at least 10% of a rubber; said bonding layer being in direct contact with one surface of

a layered metallic construct comprising one or more continuous metal layers wherein at least one of the continuous metal layers is a microcrystalline and/or amorphous metal layer having a grain size below 5000 nm and wherein the layered metallic construct has a peel strength>10N/cm.

Metal coatings are being used, inter alia, for decorative purposes. For example, U.S. Pat. No. 6,762,381 to Kunthady et al. discloses push buttons made of a thermoplastic material, the key tops of which are coated with a metal layer. Similarly, plastic caps of cosmetic bottles are often coated with Al or Ni to impart a “silver” look, which creates a connotation of luxury.

The production of circuit boards requires the deposition of a patterned metal coating onto a non-conductive board, such as a glass fiber reinforced resin board. Manufacturers of circuit boards are interested in providing strong adhesion of the metal coating to the resin board for the purpose of ensuring that electrical conductivity of the metal coating is preserved throughout its service life. For the mechanical properties of the resulting circuit boards these manufacturers rely primarily or exclusively on the properties of the resin, as a pattern of thin threads of metal cannot be expected to contribute appreciably to the mechanical properties of the circuit board.

It is known that nanocrystalline metals have desirable mechanical properties. U.S. Pat. No. 5,352,266 to Erb et al. makes use of these properties by providing a wear resistant coating of nanocrystalline metal to a substrate. The bulk mechanical properties of the constructs disclosed in Erb et al. are determined primarily by the mechanical properties of the substrate. Thus, constructs of the type disclosed in Erb et al. have surface mechanical properties derived from the nature of the metallic coating, and bulk mechanical properties derived primarily from the nature of the substrate.

The present invention is based on the discovery that both the surface mechanical properties, such as hardness and wear resistance, and the bulk mechanical properties, such as flexural, tensile, torsional, impact and fatigue strength, of an article can be improved by the presence of a metal coating (in the form of a layered metallic construct) and an intermediate bonding layer, provided the following conditions are met.

Firstly, the bonding layer must be in direct contact with both the substrate and the layered metallic construct. This is contrary to the teachings of U.S. Pat. No. 4,389,268 to Oshima et al, which discloses the use of an insulating sheet for preventing bonding layer molecules from diffusing into the substrate.

Secondly, the bonding layer must contain a curable resin and at least 10 wt % of a rubber. This is contrary to the teachings of US 2010/0304065, US 2010/0304171, 2010/0304063, US 2010/0304065, and unpublished application Ser. No. 13/279,731, which disclose the use of intermediate layers that do not contain rubber.

Thirdly, the bonding layer must be substantially fully cured before the layered metallic construct is deposited.

Fourthly, the layered metallic construct must comprise one or more continuous metal layers, as distinguished from a pattern such as is found in a circuit board.

In an embodiment the substrate comprises a polymeric resin. Examples of suitable polymeric resins include unfilled or filled epoxy, phenolic and melamine resins, polyester resins, urea resins; thermoplastic polymers such as thermoplastic polyolefins (TPOs) including polyethylene (PE) and polypropylene (PP); polyamides, mineral filled polyamide resin composites; polyphthalamides, polyphtalates, polystyrene, polysulfone, polyimides; neoprenes; polybutadienes; polyisoprenes; butadiene-styrene copolymers; poly-ether-ether-ketone (PEEK); poly-aryl ether ketones (PAEK), poly ether ketones (PEK), poly ether ketone ketones (PEKK) polycarbonates; polyethyleneimines (PEI); polyphenylene sulfides (PPS); polyesters; self-reinforcing polyphenylenes; poly-aryl amides (PARA) liquid crystal polymers such as partially crystalline aromatic polyesters based on p-hydroxybenzoic acid and related monomers; polycarbonates; chlorinated polymers such polyvinyl chloride (PVC); fluorinated polymers such as polytetrafluoroethylene (PTFE); and suitable blends of the above-mentioned polymers. The polymeric resin of the substrate can be fiber reinforced. Examples of reinforcing fibers include glass fibers, aramide fibers, carbon fibers, carbon nanotubes, and the like. The reinforcement may be short or continuous. The polymeric resin of the substrate may be fabricated using methods including, but not limited to, injection molding, machining, compression molding and additive manufacturing processes such as stereolithography (SLA), selective laser sintering (SLS), and fused deposition modeling (FDM).

In another embodiment the substrate comprises a metallic material. Examples of suitable metallic materials include metals and alloys of aluminum, titanium, and magnesium.

Also within the scope of the present disclosure are substrates that are open and closed cell foams, cellular molded structures, other honeycomb type structures and trusses. The person skilled in the art will know that these structures may be provided with a continuous outer surface layer for metal deposition.

The curable resin component of the bonding layer can be any thermoset resin that can be cured or “set” by crosslinking. Particularly suitable are epoxy resins, (but not limited to): Solid and liquid epoxies from Bisphenol A, Bisphenol F, Diglycidyl Ether of Bisphenol A (DGEBPA), Diglycidyl Ether of Bisphenol F (DGEBPF), Modified epoxies including Carboxyl terminated Butadiene acrylonitrile polymer (CTBN) adducted epoxies of DGBPA and DGBPF, and Cresyl Glycidyl Ether or n-Butyl Glycidyl Ether or Phenyl Glycidyl Ether modified epoxy resins of DGBPA and DGBPF. The rubber component of the bonding layer can be any alkadiene polymer, such as neoprene rubber; isoprene rubber; butadiene rubber, and the like. Preferred rubbers are Carboxyl terminated Butadiene acrylonitrile polymer (CTBN) and/or Amine terminated Butadiene acrylonitrile polymer (ATBN). Modified epoxies containing rubber adducts are also suitable. Butadiene rubber is particularly suitable for use herein. The bonding layer preferably contains at least 10%, preferably at least 20%, more preferably at least 25% rubber, and less than 80%, preferably less than 60% and more preferably less than 50% rubber by weight of the curable resin.

The bonding layer optionally contains a curing agent. Any curing agent known in the art is suitable for this purpose. Particularly suitable are curing agents selected from the group consisting of amide-type, amine-type and imidazole-type curing agents, more particularly imidazole-type curing agents.

The microcrystalline and/or amorphous metal layer or layers of the layered metal construct can comprise one or more metals selected from the group consisting of Ag, Al, Au, Co, Cr, Cu, Fe, Ni, Mo, Pd, Rh, Ru, Sn, Ti, W, Zn, and Zr. The microcrystalline and/or amorphous layer or layers may comprise an alloy of at least two metals or at least one element of the group consisting of B, C, H, P, and S.

In an embodiment the microcrystalline and/or amorphous metal layer or layers of the layered metal construct can comprise metal matrix composites. Metal matrix composites (MMCs) in this context are defined as particulate matter embedded in a fine-grained and/or amorphous metal matrix. MMCs can be produced, e.g., in the case of using an electroless plating or electroplating process by suspending particles in a suitable plating bath and incorporating particulate matter into the deposit by inclusion or, e.g., in the case of cold spraying by adding non-deformable particulates to the powder feed, or by forming particles in-situ from a plating bath at the deposition electrode. The particle additives include powders, fibers, nanotubes, flakes, metal powders, metal alloy powders and metal oxide powders of Al, Co, Cu, In, Mg, Ni, Si, Sn, V, and Zn; nitrides of Al, B and Si; C (graphite, diamond, nanotubes, Buckminster Fullerenes); carbides of B, Cr, Bi, Si, W; and self lubricating materials such as MoS₂ or organic materials e.g. PTFE.

The microcrystalline and/or amorphous layer or layers have a grain size of less than 5000 nm, preferably less than 100 nm, more preferably less than 20 nm. As a general rule, the mechanical properties, such as hardness and yield strength, of a metal improve as the grain size decreases. This is known as the Hall-Petch effect. The layered metallic construct can further comprise an intermediate conductive layer in contact with the bonding layer. Any conductive metal can be used for this intermediate conductive layer. Particularly suitable metals include Ag, Ni, Co, Cu, and alloys and mixtures thereof.

In another aspect the invention provides a process for providing an article of manufacture with a metal coating, said process comprising the steps of:

providing an article of manufacture having an outer surface;

coating the outer surface of the article, or a predetermined portion thereof, with a composition comprising a curable resin;

substantially fully curing the curable resin to form a bonding layer;

coating the bonding layer with a layered metallic construct comprising one or more continuous metal layers wherein at least one of the continuous metal layers is a microcrystalline and/or amorphous metal layer having a grain size below 5000 nm;

annealing the coated article.

The process results in very strong bonds between the substrate and the bonding layer, and between the bonding layer and the layered metallic construct. The process can be used in the manufacture of any article in which strong adhesion of a metal coating to a substrate is desirable or necessary. The process is particularly suitable for the manufacture of articles that require high flexural, tensile, torsional, impact and/or fatigue strength, such as sporting goods and components of sporting goods; automotive parts; aircraft components; building materials; and the like.

An important aspect of the process of the invention is the step of substantially fully curing the bonding layer prior to depositing the layered metallic structure. Cross-linking is an exothermic process, and its progress can be followed by such techniques as differential scanning calorimetry (DSC), thermogravimetric analysis (TGA) and differential thermal analysis. For the purpose of the present invention a curable resin sample is considered substantially fully cured when the Isothermal DTA curve no longer shows a measurable negative heat release (or positive heat uptake). It will be understood that even when there is no longer any measurable heat uptake at the curing temperature (and the resin is considered substantially cured) some residual cross-linkable bonds may still be present in the resin. In fact, some residual cross-linking reactions may still be taking place. However, the cross-linking reaction, if any is remaining, has become so slow as to escape measurement. For all practical purposes the curing process is complete, and can be discontinued.

In general, the resin compositions used for forming the bonding layer can be cured at temperatures below 150° C. For example, curing at about 140° C. for 2 hours, or at 120° C. for 4 hours is generally sufficient to accomplish substantially full curing. This is significantly lower than prior art bonding layers used for printed circuit boards, which typically require curing at 180° C. The relatively low curing temperatures of the process of this invention are advantageous for substrates that comprise a polymer resin, which could become deformed, or chemically or structurally damaged if exposed to temperatures above 150° C. The layered metallic structure can be deposited onto the substantially fully cured bonding layer by any suitable technique, including chemical deposition, vapor deposition, sputtering, and electrodeposition. In a preferred embodiment of the process a conductive layer is first deposited by electroless deposition. The conductive layer can be, for example, Ag, Ni, Co, Cu, or an alloy or a mixture thereof. This step prepares the article for receiving one or more microcrystalline metal layers by a metal deposition process. Particularly preferred is electrodeposition by a pulsed DC current, as disclosed in U.S. Pat. No. 5,352,266 to Erb et al., the disclosures of which are incorporated herein by reference. Electrodeposition by a pulsed current results in a metal layer having a grain size of less than 20 nm, having desirable hardness and strength.

The annealing step has been found to significantly increase the adhesion between the several layers. The annealing step is a heat treatment step, similar to the curing step in terms of temperature and duration. For example, the annealing step can be a heat treatment at about 140° C. for two hours.

The peel strength of the layered metallic structure provides a measure of the mechanical properties of the coated article. The process of the invention generally produces peel strength values of 10 N/cm or more. The peel strength values are believed to correlate well with other mechanical properties of the article, such as flexural, tensile, torsional, impact and/or fatigue strength. Moreover, low peel strength values lead to delamination of the metal coating at relatively low strains resulting in lower flexural, tensile, torsional, impact and/or fatigue strength of the coated article. The present disclosure focuses on the selection of the optimal metal layer construct, bonding material, and substrate combinations to derive lightweight components with extremely high specific load carrying capability. In other words, it is an objective of the present disclosure to provide high-strength coated articles with the lowest possible clad-metal thickness for a given design load, having enhanced stiffness, breaking strength under tensile, flexural and torsional loading, exhibiting excellent adhesion, pull-off strength, peel strength, shear strength and thermal cycling performance for use in structural applications, e.g., in automotive, aerospace and defense applications, industrial components, electronic equipment or appliances and sporting goods, molding applications and medical applications.

Importantly, this invention can provide coated articles, which, at service temperatures higher than room temperature, retain more strength and stiffness, than articles made of only the substrate.

This invention can also provide coated articles which have a higher fatigue limit than the equivalent volume and shape article made from the substrate material only, as well as conventional coarse-grained metal-coated substrates of the similar chemical composition and overall weight, preferably at least 100 cycles and higher at 100% of the design (i.e., rated) and/or yield stress of the article, and more preferably ≧1000 cycles at 80% of the design and/or yield stress of the article, and more preferably, ≧10,000 cycles and higher at 60% of the design and/or yield stress, and more preferably ≧100,000 cycles or higher at 40% of the design and/or yield stress, and even more preferably >1 million cycles at 20% of the design and/or yield stress, and a ‘run-off’, implying no fatigue failures, preferably at 10 million cycles or more.

It is desirable to prepare a surface before it receives a coating. For example, the outer surface of the substrate can be pretreated prior to the step of coating this outer surface with the composition comprising a curable resin. The pretreatment can comprise etching or solvent wiping. Etching can be, for example, accomplished with permanganate or sulfochromic chemical etch, or with a plasma etch.

The composition comprising the curable resin can, for example, be applied by spraying. For this purpose the composition desirably comprises a solvent, in a sufficient amount to obtain a viscosity suitable for spraying. It has been found that preferred solvents have a boiling point of less than 100° C., to ensure ready and complete evaporation early in the curing step. Particularly preferred is acetone (boiling point 56° C.). The importance of the boiling point of the solvent is related to the need to have the film substantially fully cured. In addition to being fully cured, it is important that the bonding layer has substantially no dissolved solvents.

When applied by spraying, the bonding layer is generally applied at about 3 to 20 mg/cm², preferably from 5 to 15 mg/cm². It is advantageous to apply the bonding material in two or more sprayed layers, with a partial curing (for example 30 minutes at 140° C.) between applications.

After substantially full curing the bonding layer can be pretreated prior to depositing the layered metallic structure. This pretreatment can comprise mechanically roughening and/or etching. Etching can be done with a permanganate or sulfochromic acid solution. Excessive etching is to be avoided as too much of the bonding layer material may be removed.

The step of substantially curing the bonding layer stabilizes the bonding layer and its surface properties. It has been found that the layered metallic construct can be deposited onto the bonding layer after a time interval of days or weeks after the curing step, without significant adverse effects on the resulting peel strength. This results in significant advantages in terms of manufacturing logistics. Thus, the substrate may be provided with the bonding layer in one location, then shipped to a second location, remote from the first, for metallic coating.

It is also possible to provide the bonding layer as a freestanding or supported surfacing film or pre-preg. The bonding layer film or pre-preg used in this process can be fabricated from the liquid epoxy formulation using standard industry practices used for fabricating thin film epoxy adhesive films and pre-pregs from heavily solvent bearing formulations. The film or pre-preg can be shipped in sheet form to the manufacturer of the substrate, who applies it to the substrate and carries out the final curing step. The article can then be shipped back to the first location, or onward to a third location, for application of the metal coating. In this manner, the substrate and bonding material are cured simultaneously. This method is particularly suitable for substrates that require curing, such as epoxy-based fiber-reinforced composites. Of course, other permutations and combinations of these steps are possible.

In yet another embodiment, the bonding material is applied as a first layer in a lay-up mold, followed by one or more layers of a fiber/resin mixture for the substrate. The bonding layer can be cured in the mold, together with the substrate. The bonding material is thus suitable for use with substrate fabrication techniques such as resin transfer molding (RTM) and vacuum infusion, for instance.

In yet another embodiment, the layered metal construct is formed as a first process step by deposition onto a temporary removable mandrel. The bonding layer is then applied to the outer surface of the layered metal construct, optionally before or after the temporary mandrel is removed. The substrate is then applied to the outer surface of the bonding layer, optionally before or after the temporary mandrel is removed.

### DESCRIPTION OF ILLUSTRATIVE EMBODIMENTS/EXAMPLES

The following is a description of certain embodiments of the invention, given by way of example only and with reference to the drawings.

ASTM B533-85 is a test method used for measuring the force required to peel a metallic coating from a plastic substrate. A properly prepared standard test specimen, called a plaque, is electroplated and a strip of the electroplated metal is peeled from the substrate at a right angle using an instrument that indicates the force required to separate it from the substrate. ASTM B533-85 specifies the use of electroplated Cu only. For the purposes of the present application, it may be desirable to utilize materials other than electroplated Cu for the layered metallic construct material. In these cases, the test method of ASTM B533-85 is used to quantify the peel strength of the layered metallic construct. Other than the chemical composition of the layered metallic construct, the procedure outlined in ASTM B533-85 is followed.

The ASTM D4541-09 test method covers a procedure for evaluating the pull-off strength of a coating system from rigid substrates such as metal, plastic, and wood. The test determines either the greatest perpendicular force (in tension) that a surface area can bear before a plug of material is detached, or whether the surface remains intact at a prescribed force (pass/fail).

### Example 1

### Bonding Layer Application Method and Peel Strength Test

An article of the present invention, consisting of a carbon fiber reinforced plastic (CFRP) substrate, a bonding layer and a microcrystalline layered metallic construct, was fabricated using the procedure described below. A CFRP panel, 300 mm×300 mm×3 mm, was made in an autoclave from MTM49-3 pre-preg from Advanced Composites Group using standard composite fabrication practices. The CFRP substrate was pre-treated by wiping with an organic solvent (MEK) to remove any residual mold release agent. The substrate was then sprayed with the epoxy based bonding layer formula described in Table 1 to a weight of 8 mg/cm² using a gravity feed type, HVLP (high volume-low pressure) epoxy spray gun operated at 60 psi.

The coated substrate was then cured in a furnace at 143° C. for 60 minutes to fully cure the bonding layer. The surface of the substantially fully cured bonding layer was then sanded with 800 grit silicon carbide abrasive paper to result in a surface roughness of less than 0.8 μm Ra. The article was then etched and metallized using standard permanganate etching and electroless nickel metallization procedures used for plating grade plastics such as that described in Table 2. The article was then coated with 40 nm of nanocrystalline nickel following the process described in U.S. Pat. No. 5,433,797. A peel test was performed on a section of the sample following ASTM B533-85 resulting in a peel strength of less than 5 N/cm. The article was then annealed in a furnace at 143° C. for 2 hours. A second peel test was performed on another section of the article resulting in a peel strength of 15 N/cm.

TABLE 1

| Chemical | Amount (g) |
|---|---|
| Epoxy | 100 |
| Rubber | 64 |
| Fumed Silica | 14 |
| Curing agent (dicyandiamide) | 3 |
| Diethylene Glycol Monoethyl Ether | 96 |
| Solvent (25% Methyl Amyl ketone, | 142 |
| 25% Ethyl Acetone, 50% n-butyl | |
| acetate) | |

TABLE 2

| Step | Supplier | Process Conditions |
|---|---|---|
| Permanganate etch | MacDermid Inc. CT, | 65° C. for 10 min; mechanical |
| | USA | agitation |
| Rinse | DI water | Room temperature, air agitation |
| Neutralizer (79225) | MacDermid Inc, CT | Room temperature for 5 min, no |
| | USA | agitation |
| Rinse | DI Water | Room temperature, air agitation |
| Activator (Mactivate 48) | MacDermid Inc, CT | 30° C. for 5 min; no agitation |
| | USA | |
| Rinse | DI Water | Room temperature, no agitation |
| Accelerator (PM964) | Dow Chemical, MA | 45° C. for 5 min; mild air agitation |
| | USA | |
| Rinse | DI Water | Room temperature, air agitation |
| Electroless Ni (Macuplex | MacDermid Inc, CT | 35° C. for 10 min; no agitation |
| J64) | USA | |
| Rinse | DI water | Room temperature, air agitation |
| Electrolytic Copper (Ebrite | EPI, MA USA | Room temperature for 10 min, 35 mA/cm² |
| 200) | | |
| Rinse | DI Water | Room temperature, air agitation |

### Example 2

### Bonding Film Co-Cure and Peel Strength Test

A batch of epoxy bonding layer was mixed to the composition listed in Table 1 with the exception that the Diethylene Glycol Monoethyl Ether was replaced with acetone. The mixed formula was then converted to a semi-cured unsupported bonding layer film with an areal density of 0.025 psf on a temporary backing paper (white release paper) using standard industry practices for fabricating adhesive films from solvent based epoxy formulations. The bonding layer film was removed from the backing paper and laid up onto a mold surface. Four layers of 150 gsm twill carbon fiber pre-preg (MTM49-3 from Advanced Composites Group) were laid up on top of the bonding layer film and then vacuum bagged following standard industry practice for composite fabrication. The assembly was then cured in a furnace under vacuum for 2 hrs at 143° C. to fully cure the composite and bonding layer simultaneously. The cured panel was then etched, metallized and coated with 40 μm of nanocrystalline nickel following the same procedure described in Example 1. The peel strength was measured after annealing the article at 143° C. for 2 hrs, resulting in a peel strength 15 N/cm.

### Example 3

### Bonding Layer on Metal Film

An article of the present invention was fabricated by first applying a 40 μm thick layer of nanocrystalline Ni-20Fe onto a temporary mold surface. The surface of the NiFe layer was then etched with 5% H₂SO₄ solution followed by application of SAMP Primer OP272 obtained from Aculon Industries by brushing onto the surface. The epoxy-based bonding material described in Example 1 was then applied by spraying onto the surface and cured for 4 hrs at 120° C. Four layers of 150 gsm twill carbon fiber pre-preg (MTM49-3 from Advanced Composites Group) were laid up on top of the cured bonding layer film and then vacuum bagged following standard industry practice for composite fabrication. The assembly was then cured in a furnace under vacuum for 2 hrs at 120° C. to fully cure the composite. Peel strength testing per ASTM B533-85 performed on the resulting article revealed a peel strength of 11 N/cm.

### Example 4

### Synergistic Mechanical Properties of Metal-Clad Article

A series of carbon fiber reinforced plastic (CFRP) test panels (150 mm×10 mm×3 mm thick) were fabricated in an autoclave from unidirectional carbon fiber pre-preg obtained from Advanced Composites Group (MTM49-3). One side of each CFRP panel was solvent cleaned and sprayed with the epoxy based bonding layer of Table 1 to provide a bonding layer with an approximate areal density of 8 mg/cm². The panels were then cured in an oven at 143° C. for 2 hours to substantially fully cure the bonding layer of each panel.

The panels were etched and metalized using the standard permanganate etching and electroless nickel metallization procedure described in Table 2. One side of one panel was coated with nanocrystalline nickel (average grain size of 20 nm) to a coating thickness of 0.1 mm while one side of a second panel was coated in an identical fashion with nanocrystalline nickel (average grain size of 20 nm) to a coating thickness of 0.2 mm. Following coating the samples were annealed at 143° C. for 2 hours. In addition to the nanocrystalline nickel coated samples, an uncoated CFRP reference sample was fabricated in an otherwise identical fashion. Three point bending was then performed on the samples following the method described in ASTM D790-03, “Standard Test Methods for Flexural Properties of Unreinforced and Reinforced Plastics and Electrical Insulating Materials”. Samples were tested in three point bend testing with the coating side in compression. The resulting bend strength values at fracture are shown in Table 3 below. The data shows that a significant increase in bend strength was unexpectedly achieved with the metal-clad samples as compared to the uncoated sample.

TABLE 3

| | Bend Strength |
|---|---|
| Uncoated | 1146 ± 92 MPa |
| 0.1 mm Ni | 1953 ± 102 MPa |
| 0.2 mm Ni | 2187 ± 139 MPa |

### Example 5

### Comparison of Bonding Layer

Three carbon fiber reinforced plastic (CFRP) test panels (150 mm×10 mm×1.25 mm thick) were fabricated in an autoclave from unidirectional carbon fiber pre-preg obtained from Advanced Composites Group (MTM49-3/CF3202). The samples were then processed as follows: panel A received no bonding layer, panel B received an 8 mg/cm² layer of T-88 rubber-free aerospace epoxy adhesive obtained from System Three Inc., following the recommended application method, and panel C received the same epoxy-rubber bonding layer described in Example 1. Each of the samples was etched, metallized and one side coated with nanostructured nickel (average grain size of 20 nm) to a coating thickness of 0.1 mm thickness in an identical fashion to the samples described in Example 1.

Following coating sample C was annealed at 143° C. for 2 hours. Three point bending was then performed on the samples following the method described in ASTM D790-03, “Standard Test Methods for Flexural Properties of Unreinforced and Reinforced Plastics and Electrical Insulating Materials”. Samples were tested in three point bending with the coating side in compression. The metal coatings on Samples A and B were found to debond at a very low displacement/strain values as shown in Table 4 and FIG. 8. For applications involving metal-coated coated composite structures it is essential for the function of the article that no coating delamination occurs in the article when the component is strained appreciably below the yield strength of the composite. The bend test data of Table 4 shows the benefit of the inventive bonding layer in providing both good adhesion strength and bending strain tolerance over a non-rubber containing epoxy bond layer or no bond layer at all.

TABLE 4

| | | | Strain at | |
|---|---|---|---|---|
| | Bonding | Metal | Coating | Peel |
| | Layer | Thickness | Debond | Strength |
| Panel A | None | 0.1 mm | 0.9% | <1 N/cm |
| Panel B | T-88 Epoxy | 0.1 mm | 0.7% | <1 N/cm |
| Panel C | present | 0.1 mm | 2.7% | 23 N/cm |
| | invention | | | |

### Example 6

### Metal-Clad Aluminum Aircraft Flaps

Aircraft flaps are used on both leading edges and trailing edges to increase lift or drag, respectively, and are their skins are made of high strength Aluminum alloys, such as Al-6061, or Al-7055. The part surface is usually treated with a hard wear-resistant coating, such as hard-chrome plating, or a corrosion resistant coating such as sulfamate nickel. However, there are several issues with such coatings, notably that they may induce a decrease in the fatigue performance of the aluminum-based article, galvanic corrosion effects, etc. Coatings provided in conformance with the present disclosure can provide erosion protection to the aluminum without the negative effects of decreased fatigue performance and/or galvanic corrosion.

The adhesion between the layered metallic construct and aluminum substrate is crucial to the performance of the article. The present example teaches the methodology of creating a high strength, strongly adherent layered metallic cladding on an aluminum aircraft flap, through the application of the intermediate bonding layer between the layered metallic construct and the aluminum substrate. In order to illustrate the high coating adhesion of the metal-clad aluminum parts when processed according to the inventive process, the flap parts were metalized using various process combinations listed Table 5, namely, with and without a curable resin-based bonding layer, with and without an anodizing pre-treatment, and so on.

Several flap skins made of aluminum alloy 6061 were obtained from an aircraft parts supplier. The flap skin surfaces were subjected to the following steps prior to metallization:

(i) the parts were completely immersed in an MEK degreasing solution for 1 minute, and wiped clean with cloth, to remove any grease on the surface;

(ii) A standard Class 1 anodizing process was carried out

(iii) After degreasing, parts were racked on a frame-wire rack. The parts were uniformly sprayed with the bonding material of Example 1

(iv) Parts were cured at 143° C. for 2 hours.

(v) Sanding on the bonding material was performed with 800 grit silicon carbide abrasive paper to smoothen the surface

The parts were then etched, metallized and coated with 40 μm of nanocrystalline nickel following the same procedure described in Example 1. The parts were then annealed at 143° C. for 2 hrs. ASTM B533 Peel strength testing was performed on the variously processed parts, and the results of the peel strength testing are shown in Table 5. For comparison, a flap part was also metalized using a conventional aluminum metallization process (Atotech GmbH, Alklean 77, followed by Alumetch and Double Alumseal processes), and peel testing was conducted for baseline values.

TABLE 5

| | Pre-treatment | Inventive | |
|---|---|---|---|
| | (Class 1 | Bonding | Peel Strength |
| Process | Anodizing) | Layer? | (N/cm) |
| Conventional | NO | NO | 8-9 |
| Aluminum | | | |
| metallization (double | | | |
| zincate process) | | | |
| Integran Sample 1 | NO | YES | 2-6 N/cm |
| Integran Sample 2 | YES | YES | 15-20 N/cm |

### Example 7

### Metal-Clad Additive Manufactured Automotive Manifolds

The present example teaches the methodology of creating a high strength, strongly adherent layered metallic cladding on additive manufactured (alternatively known as rapid prototyped, or direct digital manufactured) polymeric automotive manifolds. To illustrate the range of rapid prototyped polymers and processes that can be used in conjunction with the present invention, three different polymer substrate types and processes were selected to construct the manifolds: a) ULTEM 9085 Polyetherimide (Fortus Inc.) constructed through Fused Deposition Modeling (FDM); b) PEEK HP3 Polyetheretherketone (EOS, Germany) constructed through a Selective Laser Sintering (SLS) Process, and; c) Polyphenylene Sulfone (Stratasys Inc) through an FDM process. One automotive manifold substrate was fabricated using each of these three additive manufacturing processes. The three individual parts were then lightly sanded to obtain a good surface finish (0.8-6.3 μm Rₐ) and metalized using the following steps:

(i) the parts were completely immersed in an MEK degreasing solution for 1 minute, and wiped clean with a cloth to remove any grease on the surface;

(ii) After degreasing, parts were racked on a frame-wire rack. The parts were uniformly sprayed with the bonding material of Example 1;

(iii) Parts were cured at 143° C. for 2 hours;

(iv) Sanding of the bonding material was performed with 800 grit silicon carbide abrasive paper to smoothen the surface.

The parts were then etched, metallized and coated with 100 μm of nanocrystalline nickel following the same procedure described in Example 1. The parts were then annealed at 143° C. for 2 hrs. ASTM B533 Peel strength testing was performed on the variously processed parts, and the results of the peel strength testing are shown in Table 6. High peel strength values were achieved in all three cases. The resultant articles consisting of metal clad additive manufactured substrates processed using the inventive process provide a unique set of advantages including, but not limited to, light weight component construction compared to the incumbent machined or formed aluminum alloy or steel manifolds, and excellent mechanical performance at elevated service temperatures originating from high interfacial strength between the constituent layers of construction.

TABLE 6

| | | Peel Strength |
|---|---|---|
| Process | Substrate Type | (N/cm) |
| Fused Deposition | ULTEM 9085 PEI | 15-17 N/cm |
| Modeling (FDM) | | |
| Selective Laser | PEEK HP3 | 14-18 N/cm |
| Sintering (SLS) | | |
| Fused Deposition | PPSU Polyphenylene | 15-20 N/cm |
| Modeling (FDM) | sulfone | |

What is claimed is:

1. An article of manufacture comprising:
(i) a substrate, in direct contact with
(ii) a bonding layer of a substantially fully cured resin comprising at least 10% of a rubber; said bonding layer being in direct contact with one surface of
(iii) a layered metallic construct comprising one or more continuous metal layers wherein at least one of the continuous metal layers is a microcrystalline and/or amorphous metal layer having a grain size below 5000 nm and wherein the layered metallic construct has a peel strength>10N/cm.

2. The article of claim 1 wherein the substrate comprises a polymeric resin.

3. The article of claim 2 wherein the substrate comprises a fiber reinforced resin.

4. The article of claim 3 wherein the substrate comprises a carbon fiber reinforced resin.

5. The article of claim 1 wherein the substrate comprises a metallic material.

6. The article of claim 1 wherein the substantially fully cured resin comprises an epoxy resin.

7. The article of claim 6 wherein the substantially fully cured resin comprises from 10 to 80 wt % rubber by weight of the epoxy resin.

8. The process of claim 7 wherein the rubber is a butadiene rubber.

9. The article of claim 7 wherein the substantially fully cured resin comprises from 0.5 to 3 wt % of a curing agent, by weight of the epoxy resin.

10. The article of claim 7 wherein the curing agent is selected from the group consisting of amide-type, amine-type and imidazole-type curing agent.

11. The article of claim 10 wherein the curing agent is an imidazole-type curing agent.

12. The article of claim 1 wherein the microcrystalline and/or amorphous metal layer comprises one or more metals selected from the group consisting of Ag, Al, Au, Co, Cr, Cu, Fe, Ni, Mo, Pd, Rh, Ru, Sn, Ti, W, Zn, and Zr.

13. The article of claim 12 wherein the microcrystalline metal layer comprises an alloy of at least two metals or at least one element selected from the group consisting of B, C, H, O, P, and S.

14. The article of claim 1 wherein the layered metallic construct further comprises an intermediate conductive layer in contact with the bonding layer.

15. The article of claim 14 wherein the intermediate conductive layer comprises a metal selected from the group consisting of Ag, Ni, Co, Cu, and alloys and mixtures thereof.

16. A process for providing an article of manufacture with a metal coating, said process comprising the steps of:
(i) providing an article of manufacture having an outer surface;
(ii) coating the outer surface of the article, or a predetermined portion thereof, with a composition comprising a curable resin;
(iii) substantially fully curing the curable resin to form a bonding layer;
(iv) coating the bonding layer with a layered metallic construct comprising one or more continuous metal layers wherein at least one of the continuous metal layers is a microcrystalline or amorphous metal layer having a grain size below 5000 nm;
(v) annealing the coated article.

17. The process of claim 16 resulting in a metal coating having peel strength of at least 10 N/cm.

18. The process of claim 16 wherein the outer surface of the article is subjected to a pretreatment prior to the step of coating the outer surface with the composition comprising a curable resin.

19. The process of claim 18 wherein the pretreatment comprises mechanical roughening or etching or solvent wiping.

20. The process of claim 19 wherein the pretreatment comprises etching with permanganate, sulfochromic acid, or plasma.

21. The process of claim 16 wherein step (ii) comprises applying the composition comprising the curable resin by spraying.

22. The process of claim 21 wherein the composition comprising the curable resin is applied in two or more spaying steps, consecutive spraying steps optionally being separated by a partial curing step and optionally by pretreatment steps e.g. mechanical roughening.

23. The process of claim 16 wherein step (ii) results in a coating of the curable resin composition having a thickness in the range of from 5 nm to 200 nm, preferably between 25 nm and 150 nm.

24. The process of claim 16 wherein step (iii) comprises heating the article to at least 140° C. for at least two hours.

25. The process of claim 16 wherein step (iii) comprises heating the article to at least 120° C. for at least 4 hours.

26. The process of claim 16 wherein step (iii) comprises heating the article to at least 80° C. for at least 2 hours.

27. The process of claim 16 wherein the composition comprising a curable resin comprises at least 10 wt % of a rubber.

28. The process of claim 27 wherein the rubber is a butadiene rubber.

29. The process of claim 27 wherein the composition further comprises an epoxy resin.

30. The process of claim 27 wherein the composition further comprises a curing agent.

31. The process of claim 27 wherein the composition further comprises a solvent having a boiling point of less than 100° C.

32. The process of claim 31 wherein the solvent comprises acetone.

33. The process of claim 16 wherein the bonding layer is subjected to a pretreatment prior to coating with the layered metallic construct.

34. The process of claim 33 wherein the pretreatment comprises sanding and/or etching.

35. The process of claim 34 wherein the pretreatment comprises etching with a permanganate or sulfochromic solution.

36. The process of claim 16 wherein step (iv) comprises metalizing the bonding layer by electroless deposition or chemical reduction, followed by an electroplating step.

37. The process of claim 36 wherein the electroplating step comprises subjecting the article to a DC voltage.

38. The process of claim 16 wherein the annealing step comprises heating the article to at least 140° C. for at least 2 hours.

39. The process of claim 16 wherein the annealing step comprises heating the article to at least 120° C. for at least 4 hours.

40. The process of claim 16 wherein the annealing step comprises heating the article to at least 80° C. for at least 2 hours.

41. The process of claim 16 wherein the microcrystalline or amorphous layer has a grain size of less than 100 nm.

42. The process of claim 4 wherein the microcrystalline or amorphous layer has a grain size of less than 20 nm.

43. The process of claim 16 wherein step (ii) comprises the substeps of:
a. applying a coat of curable resin to a sacrificial film;
b. partially curing the coat of curable resin to form a laminate;
c. applying the laminate obtained in step b. to the outer surface of the article, or a predetermined portion thereof.

44. The process of claim 16 wherein steps (i) through (iii) comprise the substeps of:
a. applying a coat of curable resin to a sacrificial film;
b. at least partially curing the coat of curable resin, to form a laminate;
c. applying the laminate obtained in step b. to an inner surface of a mold, or a predetermined portion thereof;
d. removing the sacrificial film;
e. applying a polymer substrate in the mold, covering the curable resin and any exposed inner surface of the mold;
f. substantially fully curing the curable resin to form a bonding layer, thereby at the same time curing the polymer substrate to form the article.

45. A process for providing an article of manufacture with a metal coating, said process comprising the steps of:
(i) coating a temporary mold surface with a layered metallic construct comprising one or more continuous metal layers wherein at least one of the continuous metal layers is a microcrystalline or amorphous metal layer having a grain size below 5000 nm;
(ii) optionally pre-treating the outer surface of the layered metallic construct;
(iii) coating the outer surface of the layered metallic construct, or a predetermined portion thereof, with a composition comprising a curable resin;
(iv) substantially fully curing the curable resin to form a bonding layer;
(v) applying a polymer substrate in the mold on top of the curable resin;
(vi) annealing the polymer substrate and the curable resin;
(vii) removing the temporary mold.
